(19) United States
(12) Patent Application Publication
(10) Pub. No.: US 2024/0027729 A1
(43) Pub. Date: Jan. 25, 2024

(54) PROJECTION OPTICAL APPARATUS AND PROJECTOR

(71) Applicant: SEIKO EPSON CORPORATION, Tokyo (JP)

(72) Inventors: Yuta ITO, Azumino-shi (JP); Kosho KAMIJO, Nagano-ken (JP)

(21) Appl. No.: 18/358,089

(22) Filed: Jul. 25, 2023

(30) Foreign Application Priority Data
Jul. 25, 2022 (JP) 2022-117788

(51) Int. Cl. G02B 7/18; G03B 21/28; G03B 21/16

(52) U.S. Cl. CPC G02B 7/1815; G03B 21/28; G03B 21/16

(57) ABSTRACT

A projection optical apparatus according to an aspect of the present disclosure includes an optical system that image light enters, a reflector that reflects the image light that exits out of the optical system, and an enclosure that houses the optical system and at least part of the reflector, and the reflector includes a base having a first surface on which the image light is incident and a second surface opposite from the first surface, a reflection layer provided at the first surface of the base, and a heat dissipation member provided at the second surface of the base and including a protrusion protruding from the second surface.

The present application is based on, and claims priority from JP Application Serial Number 2022-117788, filed Jul. 25, 2022, the disclosure of which is hereby incorporated by reference herein in its entirety.

### BACKGROUND

### 1. Technical Field

The present disclosure relates to a projection optical apparatus and a projector.

### 2. Related Art

In recent years, there has been a demand for short-focal-length projectors that are compact yet capable of displaying large projected images. As such a short-focal-length projector, there is a technology using a projection optical apparatus having a configuration in which lenses are combined with a concave mirror to enlarge an image reflected off the mirror and project the enlarged image onto a screen (see, JP-A-2011-085922, for example).

In the short-focal-length projector described above, image light is incident on the mirror of the projection optical apparatus with the image light focused into a spot on the mirror. The mirror may therefore be deformed due to heat generated by the locally high illuminance of the image light. The image light reflected off the deformed mirror is undesirably projected at a position off a predetermined position on the screen. There is therefore a problem of deterioration in the quality of the projected image due to the partial shift of the projected image light.

### SUMMARY

To solve the problem described above, according to an aspect of the present disclosure, there is provided a projection optical apparatus including an optical system that image light enters, a reflector that reflects the image light that exits out of the optical system, and an enclosure that houses the optical system and at least part of the reflector, and the reflector includes a base having a first surface on which the image light is incident and a second surface opposite from the first surface, a reflection layer provided at the first surface of the base, and a heat dissipation member provided at the second surface of the base and including a protrusion protruding from the second surface.

According to another aspect of the present disclosure, there is provided a projector including a light source apparatus that outputs light, a light modulator that modulates the light from the light source apparatus, and the projection optical apparatus according to the aspect described above that projects modulated image light from the light modulator.

### BRIEF DESCRIPTION OF THE DRAWINGS

FIG. 1 shows a schematic configuration of a projector according to a first embodiment.

FIG. 2 is a cross-sectional view showing a schematic configuration of a projection optical apparatus provided in the projector.

FIG. 3 shows an illuminance distribution formed on a reflection mirror.

FIG. 4 is a cross-sectional view showing a schematic configuration of a projection optical apparatus according to a second embodiment.

FIG. 5 is a cross-sectional view showing a schematic configuration of a projection optical apparatus according to a third embodiment.

FIG. 6 is a cross-sectional view showing a schematic configuration of a projection optical apparatus according to a fourth embodiment.

### DESCRIPTION OF EXEMPLARY EMBODIMENTS

Embodiments of the present disclosure will be described below in detail with reference to the drawings. In the drawings used in the description below, a characteristic portion is enlarged for convenience in some cases for clarity of the characteristic thereof, and the dimension ratio and other factors of each component are therefore not always equal to actual values.

An example of a projector according to an embodiment of the present disclosure will be described.

The projector according to the present embodiment is a projection-type image display apparatus that displays a full-color image on a screen (projection receiving surface). The projector includes three light modulators formed of liquid crystal light valves that modulate color light formed of red light, green light, and blue light.

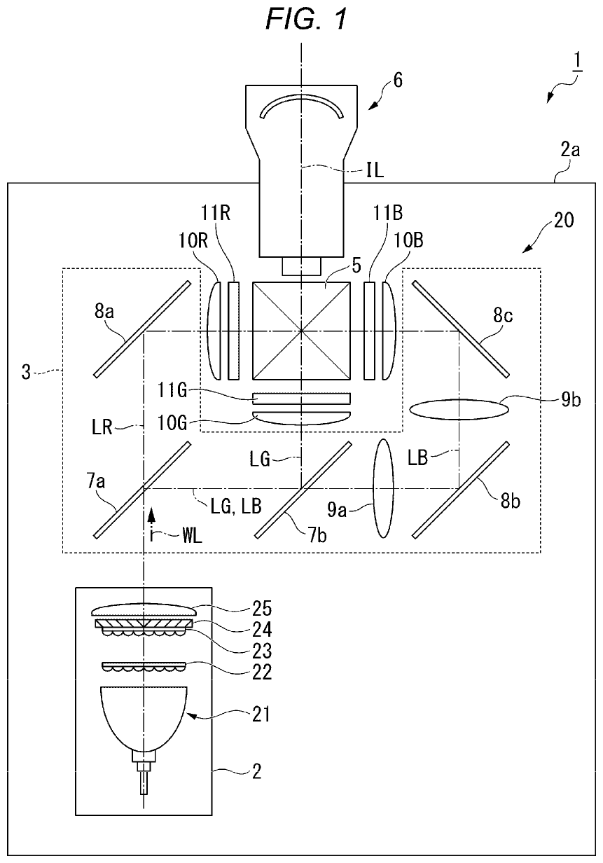

FIG. 1 shows a schematic configuration of the projector according to the present embodiment.

A projector 1 according to the present embodiment includes a body section 20, an exterior enclosure 2a, and a projection optical apparatus 6, as shown in FIG. 1. The body section 20 is housed in the exterior enclosure 2a. The exterior enclosure 2a is made, for example, of a resin material, and has a configuration in which a plurality of members are combined with each other.

The projection optical apparatus 6 is disposed so as to partially protrude from the exterior enclosure 2a. The projection optical apparatus 6 according to the present embodiment is a projection lens unit capable of ultra-short focal length projection. With the projection optical apparatus 6 attached, the projector 1 can be installed at a position close to the screen and project an image. The projection optical apparatus 6 is, however, not necessarily detachable from and attachable to the body section 20. The configuration of the projection optical apparatus 6 will be described later in detail.

The body section 20 includes a light source apparatus 2 as an illumination system, a color separation system 3, light modulators 11R, 11G, and 11B, and a light combining system 5.

The light source apparatus 2 includes a light source 21, a first lens array 22, a second lens array 23, a polarization converter 24, and a superimposing lens 25. The first lens array 22 and the second lens array 23 each have a configuration in which a plurality of microlenses are arranged in a matrix in a plane perpendicular to the optical axis.

In the projector 1 according to the present embodiment, a lamp that is a discharge-type light source is employed as the light source 21, but the light source 21 is not limited to a discharge-type light source. The light source 21 may, for example, be a solid-state light source, such as a light emitting diode and a laser, or a light source apparatus including a wavelength converter containing a phosphor that emits fluorescence when irradiated with excitation light.

Light emitted from the light source 21 is divided by the first lens array 22 into a plurality of sub-luminous fluxes. The plurality of sub-luminous fluxes are superimposed by the second lens array 23 and the superimposing lens 25 on one another in an effective display region of each of the three light modulators 11R, 11G, and 11B, which are each an illumination target. That is, the first lens array 22, the second lens array 23, and the superimposing lens 25 form an optical integration system that illuminates the light modulators 11R, 11G, and 11B with the light emitted from the light source 21 and having a substantially uniform illuminance distribution.

The polarization converter 24 converts the light emitted from the light source 21, which is non-polarized light, into linearly polarized light that can be used by the three light modulators 11R, 11G, and 11B.

The color separation system 3 separates illumination light WL from the light source apparatus 2 into red light LR, green light LG, and blue light LB. The color separation system 3 generally includes a first dichroic mirror 7a, a second dichroic mirror 7b, a first total reflection mirror 8a, a second total reflection mirror 8b, a third total reflection mirror 8c, a first relay lens 9a, and a second relay lens 9b.

The first dichroic mirror 7a separates the illumination light WL from the light source apparatus 2 into the red light LR and other light formed of the green light LG and blue light LB. The first dichroic mirror 7a transmits the separated red light LR and reflects the separated green light LG and blue light LB. On the other hand, the second dichroic mirror 7b reflects the green light LG and transmits the blue light LB to separate the other light into the green light LG and the blue light LB.

The first total reflection mirror 8a is disposed in the optical path of the red light LR and reflects the red light LR having passed through the first dichroic mirror 7a toward the light modulator 11R. On the other hand, the second total reflection mirror 8b and the third total reflection mirror 8c are disposed in the optical path of the blue light LB and guide the blue light LB having passed through the second dichroic mirror 7b to the light modulator 11B. The green light LG is reflected off the second dichroic mirror 7b toward the light modulator 11G.

The first relay lens 9a and the second relay lens 9b are disposed downstream from the second dichroic mirror 7b in the optical path of the blue light LB.

The light modulator 11R modulates the red light LR in accordance with image information to form image light corresponding to the red light LR. The light modulator 11G modulates the green light LG in accordance with image information to form image light corresponding to the green light LG. The light modulator 11B modulates the blue light LB in accordance with image information to form image light corresponding to the blue light LB.

The light modulators 11R, 11G, and 11B are each, for example, a transmissive liquid crystal panel. Pixels are arranged in each of the liquid crystal panels and modulate the light incident thereon on a pixel basis in accordance with the image information. Polarizers that are not shown are disposed on the light incident side and the light exiting side of each of the liquid crystal panels.

Field lenses 10R, 10G, and 10B are disposed at the light incident side of the light modulators 11R, 11G, and 11B, respectively. The field lenses 10R, 10G, and 10B parallelize the red light LR, the green light LG, and the blue light LB to be incident on the respective light modulators 11R, 11G, and 11B.

The light combining system 5 receives the image light from the light modulator 11R, the image light from the light modulator 11G, and the image light from the light modulator 11B. The light combining system 5 combines the image light corresponding to the red light LR, the image light corresponding to the green light LG, and the image light corresponding to the blue light LB with one another and outputs the combined image light toward the projection optical apparatus 6. The light combining system 5 is formed, for example, of a cross dichroic prism. The combined light generated by the light combining system 5 exits toward the projection optical apparatus 6.

The combined light having exited out of the body section 20 is projected as image light IL via the projection optical apparatus 6 onto the projection receiving surface, such as the screen that is not shown.

The projection optical apparatus 6 will be described below.

The projection optical apparatus 6 according to the present embodiment projects an image displayed in the reduction-side conjugate plane into the enlargement-side conjugate plane to generate a projected image. In the present embodiment, the reduction-side conjugate plane corresponds to a display surface of the liquid crystal panel of each of the light modulators 11R, 11G, and 11B, and the enlargement-side conjugate plane corresponds to the screen, which is the projection receiving surface.

The projection optical apparatus 6 according to the present embodiment forms an intermediate image of the displayed image at the position conjugate to the display surface of each of the light modulators 11R, 11G, and 11B, which is the reduction-side conjugate plane, and enlarges and projects the intermediate image onto the screen, which is the enlargement-side conjugate plane.

The following description with reference to the drawings will be made by using an XYZ orthogonal coordinate system as required. The axis Z is an axis along the upward-downward direction of an image projected by the projection optical apparatus 6 onto the screen. The axis X is an axis parallel to an optical axis AX1 of the projection optical apparatus 6. The axis Y is an axis perpendicular to the axes X and Z and extending along the rightward-leftward direction of an image projected by the projection optical apparatus 6 onto the screen.

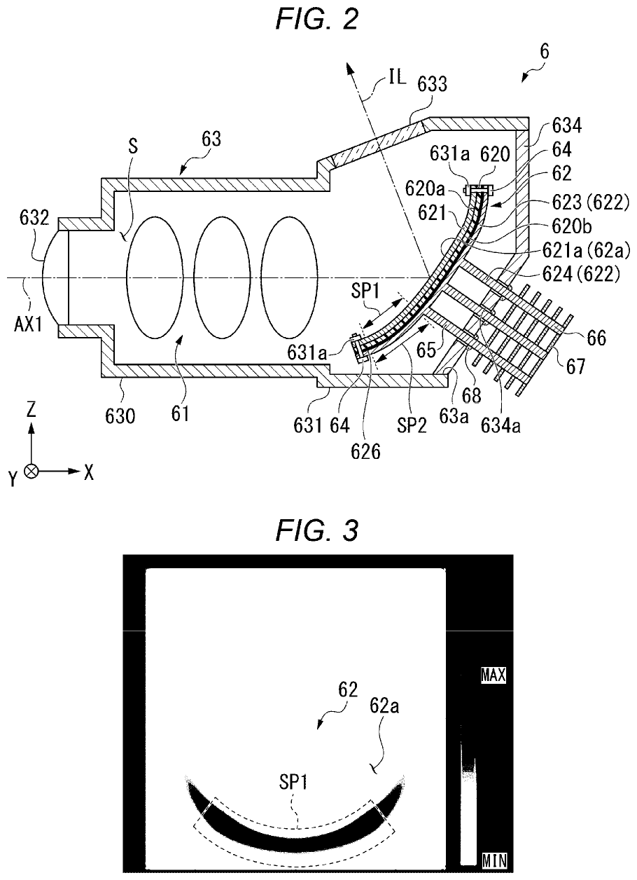

FIG. 2 is a cross-sectional view showing a schematic configuration of the projection optical apparatus 6 according to the present embodiment. FIG. 2 is a cross-sectional view of the projection optical apparatus taken along a plane parallel to the plane XZ.

The projection optical apparatus 6 includes a lens group (optical system) 61, a first reflection mirror (reflector) 62, and a first lens unit enclosure (enclosure) 63, which houses the lens group 61 and the first reflection mirror 62, as shown in FIG. 2.

The lens group 61 is formed of a plurality of lenses and causes the image light IL from the body section 20 to exit toward the first reflection mirror 62. In the lens group 61, the plurality of lenses are arranged along the optical axis AX1. The plurality of lenses that constitute the lens group 61 include lenses having a variety of shapes, such as convex and concave lenses. The number, shape, dimensions, and arrangement of the lenses that constitute the lens group 61 are not limited to specific ones.

The first reflection mirror 62 reflects the image light IL having exited out of the lens group 61 and deflects the optical path of the image light IL. The first reflection mirror 62 projects the reflected image light IL onto the projection receiving surface, which is the enlargement-side conjugate plane. A reflection surface 62a of the first reflection mirror 62 is formed of an aspherical mirror that reflects the image light IL while angularly widening the image light IL. The first reflection mirror 62 is so disposed that the reflection surface 62a faces upward (side facing positive end of direction Z) and the side opposite from the side toward which the light exits out of the lens group 61 (side facing negative end of direction X). In the present embodiment, the first reflection mirror 62 reflects the chief ray of the image light IL, which travels along the optical axis AX1 of the lens group 61, obliquely backward at an acute angle with respect to the optical axis AX1. The image light IL reflected off the first reflection mirror 62 exits toward the screen via a light exiting section 633 of the first lens unit enclosure 63, which will be described later.

Based on the configuration described above, the projection optical apparatus 6 according to the present embodiment can enlarge and project the image light IL onto the screen disposed at a short distance from the projector 1.

The first lens unit enclosure 63 includes a lens barrel 630, a mirror holder 631, a light incident section 632, the light exiting section 633, and a first cover member 634. The material, shape, dimensions, and other factors of the first lens unit enclosure 63 are not limited to specific ones.

The lens barrel 630 is a portion that houses the lens group 61, and the mirror holder 631 is a portion that holds the first reflection mirror 62. Although not shown, the lens barrel 630 includes supports that support the individual lenses that constitute the lens group 61. In the present embodiment, the mirror holder 631 includes supports 631a, which support the first reflection mirror 62. The first reflection mirror 62 is attached to the supports 631a of the mirror holder 631 with the aid of screw members 64.

The light incident section 632 captures the image light IL having exited out of the body section 20 into the projection optical apparatus 6. The light exiting section 633 causes the image light IL reflected off the first reflection mirror 62 out of the projection optical apparatus 6. The light incident section 632 and the light exiting section 633 are each formed, for example, of a light transmissive window member. In the present embodiment, the light incident section 632, for example, has a lens shape, which allows efficient capture of the image light IL.

The first lens unit enclosure 63 has a first opening 63a. In the present embodiment, the first opening 63a is provided at the mirror holder 631 of the first lens unit enclosure 63.

The first opening 63a causes the interior space of the first lens unit enclosure 63 to communicate with the exterior thereof. The lens group 61 and the first reflection mirror 62 are detachable from and attachable to the interior of the first lens unit enclosure 63 via the first opening 63a. The first cover member 634 is detachable from and attachable to the first lens unit enclosure 63 to block the first opening 63a.

The first cover member 634 hermetically seals the interior space of the first lens unit enclosure 63. That is, the first lens unit enclosure 63 in the present embodiment has a sealing structure that seals a housing space S, which houses the lens group 61 and the first reflection mirror 62. The thus configured first lens unit enclosure 63, which suppresses entry of dust into the inner housing space S, can suppress deterioration in the optical characteristics of the lens group 61 and the first reflection mirror 62 due to dust that adheres thereto, and deformation of and damage to the lens group 61 and the first reflection mirror 62 due to the dust when caused to burn.

In a short-focal-distance projector, in general, by employing a configuration in which image light is so reflected off a reflection mirror that the image light is enlarged and projected onto a screen, the light density of the image light becomes uneven on the reflection mirror, causing the illuminance distribution formed on the reflection mirror to undesirably have locally high illuminance regions.

Also in the projection optical apparatus 6 according to the present embodiment, the illuminance distribution formed on the first reflection mirror 62 by the image light IL having exited out of the body section 20 has locally high illuminance regions.

FIG. 3 shows the illuminance distribution formed on the first reflection mirror 62 in the present embodiment. Specifically, FIG. 3 shows the illuminance distribution of the image light IL formed on a reflection layer 621 and further shows the maximum illuminance of the image light IL (black) and the minimum illuminance of the image light IL (white).

On the first reflection mirror 62 in the present embodiment, the image light IL at a lower portion (portion facing negative end of the direction Z shown in FIG. 2) of the reflection surface 62a has locally high illuminance, as shown in FIG. 3. An illuminance distribution SP of the image light IL has a first region SP1, where the illuminance is higher than a predetermined value. That is, the first region SP1 means a region of the reflection surface 62a where the illuminance of the image light IL is locally high.

The predetermined value that defines the first region SP1 is preferably greater than or equal to 50% of the maximum illuminance, more preferably, greater than or equal to 60% thereof, and most preferably, greater than or equal to 70% thereof.

In the projection optical apparatus 6 according to the present embodiment, the heat dissipation capability of the first reflection mirror 62 is enhanced to lower the temperature of the first reflection mirror 62 to suppress local deformation of the first reflection mirror 62, so that a partial shift of the pixels of the projected image caused by the heat is suppressed.

The configurations of key parts of the projection optical apparatus 6 according to the present embodiment will be described below.

In the projection optical apparatus 6 according to the present embodiment, the first reflection mirror 62 includes a base 620, the reflection layer 621, and a first heat dissipation member 622. The base 620 has an inner surface (first surface) 620a, on which the image light is incident, and an outer surface (second surface) 620b, which is opposite from the inner surface 620a. The inner surface 620a of the base 620 has a concave shape. Specifically, the inner surface 620a has, for example, a spherical shape, an aspherical shape, or a free-form surface shape.

In the present embodiment, the base 620 is made of a plastic material. Since plastic is more workable than glass, the inner surface 620a can be readily and precisely formed into a desired shape. On the other hand, plastic tends to change in shape due to heat, and when the temperature of the reflection layer 621 becomes too high, the base 620 may be deformed.

The first reflection mirror 62 in the present embodiment, which includes the reflection layer 621, the heat dissipation capability of which is improved by the first heat dissipation member 622, as will be described later, allows suppression of the change in the shape of the base 620 due to heat. The first reflection mirror 62 thus has excellent workability and suppressed deformation due to heat.

The reflection layer 621 is formed along the inner surface 620a. A surface 621a of the reflection layer 621 therefore has a concave shape that conforms to the inner surface 620a. In the present embodiment, the surface 621a of the reflection layer 621 corresponds to the reflection surface 62a of the first reflection mirror 62.

The reflection layer 621 in the present embodiment is formed of a metallic or dielectric film. The metallic film that constitutes the reflection layer 621 is made, for example, of aluminum or silver. The dielectric film that constitutes the reflection layer 621 is, for example, a film that reflects visible light having wavelengths ranging from 400 nm to 700 nm. In the present embodiment, the reflection layer 621 is formed by using vapor deposition. That is, the reflection layer 621 is formed integrally with the inner surface 620a of the base 620.

It is assumed that the thickness of the reflection layer 621 is set, for example, at a value smaller than or equal to 1 μm, and that the surface 621a of the reflection layer 621 is a quasi-mirror-finish or mirror-finish surface. Specifically, the inner surface 620a of the base 620 is so formed that the surface roughness (Rz) of the surface 621a of the reflection layer 621 is smaller than or equal to 0.2 μm.

The first heat dissipation member 622 is in contact with the outer surface 620b of the base 620. The term “in contact with” means that the first heat dissipation member 622 and the outer surface of the base 620 may be in direct contact with each other, or that a heat conductive member 626, such as heat-dissipating grease, may be interposed between the first heat dissipation member 622 and the base 620. The heat conductive member 626 may be replaced with an adhesive containing heat conductive particles.

The first heat dissipation member 622 is provided at least at part of the outer surface 620b of the base 620.

In the present embodiment, the first heat dissipation member 622 is provided at least at a second region SP2 of the outer surface 620b, as shown in FIG. 2. The second region SP2 is the region corresponding to the first region SP1 of the reflection layer 621.

Specifically, the second region SP2 corresponding to the first region SP1 is a region of the outer surface 620b that overlaps with the outer shape of the first region SP1 in the direction of the shortest thickness of the reflection layer 621 and the base 620. The direction of the shortest thickness of the reflection layer 621 corresponds to the direction along a surface normal to the surface 621a of the reflection layer 621, and the direction of the shortest thickness of the base 620 corresponds to the direction along a surface normal to the surfaces of the base 620 (inner surface 620a and outer surface 620b).

The first region SP1 of the reflection layer 621 is a region where the illuminance is locally high and is therefore the hottest region of the surface 621a of the reflection layer 621. That is, out of the outer surface 620b of the base 620, the second region SP2 corresponding to the first region SP1 is the region to which the heat of the first region SP1 is likely to be transferred and is therefore the hottest region.

In the present embodiment, since the first heat dissipation member 622 is provided at least at the second region SP2 of the outer surface 620b as described above, the heat of the first region SP1, which is the hottest region of the surface 621a of the reflection layer 621, can be dissipated to the first heat dissipation member 622. The temperature of the first region SP1 can therefore be efficiently lowered, whereby the temperature of the first reflection mirror 62 can be efficiently lowered.

The first heat dissipation member 622 is preferably provided in an area greater than or equal to 80% of the entire outer surface 620b and including the second region SP2, more preferably, across the entire outer surface 620b. The heat dissipation capability of the first reflection mirror 62 can thus be further enhanced.

In the projection optical apparatus 6 according to the present embodiment, the first lens unit enclosure 63 having the sealed structure tends to accumulate heat therein. In contrast, the first reflection mirror 62 having heat dissipation capability enhanced by the first heat dissipation member 622 is unlikely to be affected by the heat accumulated in the enclosure. The projection optical apparatus 6 according to the present embodiment therefore allows both improvement in dust resistance of the first lens unit enclosure 63 and cooling of the first reflection mirror 62.

The first heat dissipation member 622 in the present embodiment includes a sheet metal member 623 provided along the outer surface 620b of the base 620, and a heat pipe 624 connected to the sheet metal member 623 and protruding from the outer surface 620b. That is, the first heat dissipation member 622 in the present embodiment includes the heat pipe 624 as a protrusion protruding from the outer surface 620b. The heat pipe 624 is fixed to the sheet metal member 623 with screw members or an adhesive. The heat pipe 624 extends toward the rear side of the outer surface 620b of base 620 diagonally downward (toward positive end of the direction X and negative end of the direction Z). The sheet metal member 623 is fixed to mirror holder 631 along with the base 620 with the screw members 64. The first heat dissipation member 622 is thus caused to come into contact with the outer surface 620b of the base 620. The first reflection mirror 62 is thus fixed to the supports 631a of the mirror holder 631 with the screw members 64.

The heat pipe 624 is formed of a refrigerant containing pipe. The heat pipe 624 has one end provided with heat receiving sections 65 and the other end provided with heat dissipating sections 66. The heat pipe 624 has a configuration in which the heat receiving sections 65 are coupled to the sheet metal member 623, and the heat dissipating sections 66 are exposed to the space outside the first lens unit enclosure 63. The heat pipe 624, in which the heat received by the heat receiving sections 65 evaporates the refrigerant into a gas and the heat dissipating sections 66 dissipate the heat of the gas to condense the gas into a liquid, can cool the sheet metal member 623. The heat pipe 624 is formed of a pipe made of metal having excellent heat conductivity, such as silver, copper, gold, and aluminum.

Part of the heat pipe 624 is exposed to the space outside the first lens unit enclosure 63. In the present embodiment, the heat dissipating sections 66 of the heat pipe 624 are exposed to the space outside the first lens unit enclosure 63. More specifically, the heat dissipating sections 66 of the heat pipe 624 are exposed to the space outside the first lens unit enclosure 63 via first slits 634a provided in the first cover member 634. The gaps between the heat dissipating sections 66 and the first slits 634a are filled with sealing members 68. The interior of the first lens unit enclosure 63 is thus hermetically sealed.

The heat pipe 624 has a configuration in which the heat dissipating sections 66, which are the portions exposed to the space outside the first lens unit enclosure 63, are provided with heat dissipating fins 67. The heat pipe 624 thus has enhanced heat dissipation capability of the heat dissipating sections 66 with the aid of the heat dissipating fins 67.

The heat dissipating fins 67 are made of metal having excellent heat conductivity, such as silver, copper, gold, and aluminum, as the heat pipe 624 is.

The step of assembling the projection optical apparatus 6 according to the present embodiment will be subsequently described.

First, the first heat dissipation member 622 is caused to come into contact with the outer surface 620b of the base 620, on which the reflection layer 621 has been deposited, via the heat conductive member 626 with the aid of the screw members 64 to assemble the second reflection mirror 162.

The first cover member 634 is subsequently attached to the first lens unit enclosure 63 to block the first opening 63a. At this point of time, the heat dissipating sections 66 of the heat pipe 624 are exposed to the space outside the first lens unit enclosure 63 via the first slits 634a of the first cover member 634.

The heat dissipating fins 67 are subsequently attached to the heat dissipating sections 66 of the heat pipe 624, which are exposed to the space outside the first lens unit enclosure 63.

Finally, the gaps between the first slits 634a of the first cover member 634 and the heat pipe 624 are filled with the sealing members 68. The assembly of the projection optical apparatus 6 is thus completed.

As described above, the projection optical apparatus 6 according to the present embodiment includes the lens group 61, which the image light IL enters, the first reflection mirror 62, which reflects the image light IL having exited out of the lens group 61, and the first lens unit enclosure 63, which houses the lens group 61 and at least part of the first reflection mirror 62, and the first reflection mirror 62 includes the base 620, which has the inner surface 620a, on which the image light IL is incident, and the outer surface 620b opposite from the inner surface 620a, the reflection layer 621, which is provided at the inner surface 620a of the base 620, and the first heat dissipation member 622, which is provided at the outer surface 620b of the base 620 and including the heat pipe 624 protruding from the outer surface 620b.

In the projection optical apparatus 6 according to the present embodiment, the first reflection mirror 62, which reflects the image light IL, includes the first heat dissipation member 622 opposite from the reflection layer 621, and the heat pipe 624 dissipates the heat absorbed from the reflection layer 621 by the first heat dissipation member 622, the temperature of the first reflection mirror 62 can be lowered.

Even when the image light IL having an uneven illuminance distribution containing locally high illuminance is incident on the reflection layer 621, the temperature of the reflection layer 621 is satisfactorily lowered, whereby a situation in which local temperature unevenness occurs at the reflection layer 621 can also be suppressed.

The projection optical apparatus 6 according to the present embodiment, in which the reflection layer 621 of the first reflection mirror 62 is unlikely to become locally hot, therefore suppresses deformation of the hot portions of the first reflection mirror 62. A high-quality image having a suppressed partial shift of the pixels of the projected image caused by the heat of the first reflection mirror 62 can therefore be projected.

The projector 1 according to the present embodiment includes the light source apparatus 2, which outputs illumination light, the light modulators 11R, 11G, and 11B, which modulate the illumination light from the light source apparatus 2, and the projection optical apparatus 6, which projects the light modulated by the light modulators 11R, 11G, and 11B.

The projector 1 according to the present embodiment, which includes the projection optical apparatus 6, which suppresses a partial shift of the pixels of the projected image caused by the heat of the first reflection mirror 62, can be a single-focus projector that projects a high-quality image onto a screen over a short distance.

The projector 1 according to the present embodiment is, for example, optimum for an interactive projector having an interactive function of reflecting on-screen detected position information in the projected image.

An interactive projector in general projects infrared light in the form of a grid pattern on a screen via an optical system different from a projection optical apparatus, and acquires information on a position on a projected image to which a user's fingertip, the tip of a pen, or any other pointing object points based on the grid pattern. It is a prerequisite for an interactive projector that the coordinates in the projected image coincide with the coordinates in the grid pattern. Therefore, if the pixels of the projected image move, the coordinates in the projected image do not coincide with the coordinates in the grid pattern, so that the interactive function cannot be fully provided. In contrast, the projector 1 according to the present embodiment can suppress a shift of the pixels of the projected image caused by the heat of the first reflection mirror 62, whereby the interactive function can be provided in a stable manner.

### Second Embodiment

Another configuration of the projection optical apparatus will be subsequently described as a second embodiment of the present disclosure. The present embodiment and the first embodiment differ from each other in terms of the structure of the reflection mirror, and the configurations of the reflection mirror and therearound will therefore be primarily described below. In the present embodiment, configurations or members common to those in the first embodiment have the same reference characters and will not be described in detail.

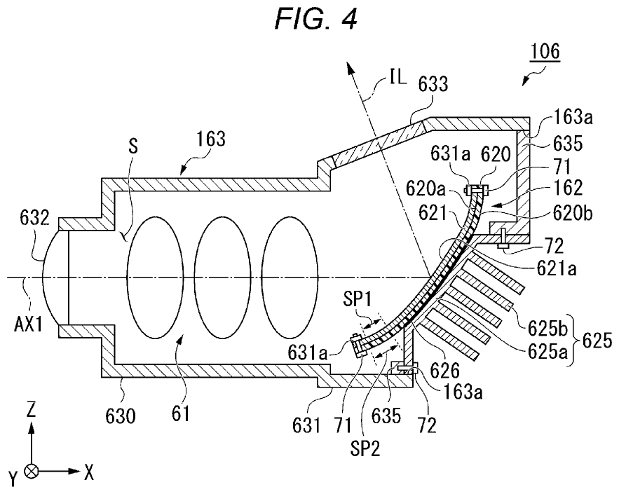

FIG. 4 is a cross-sectional view showing a schematic configuration of the projection optical apparatus according to the present embodiment.

A projection optical apparatus 106 according to the present embodiment includes the lens group 61, a second reflection mirror (reflector) 162, and a second lens unit enclosure (enclosure) 163, which houses the lens group 61 and the second reflection mirror 162, as shown in FIG. 4.

The second lens unit enclosure 163 in the present embodiment includes the lens barrel 630, the mirror holder 631, the light incident section 632, the light exiting section 633, and a second cover member 635.

The mirror holder 631 of the second lens unit enclosure 163 has a second opening 163a. The second opening 163a causes the interior space of the second lens unit enclosure 163 to communicate with the exterior thereof. The lens group 61 is detachable from and attachable to the interior of the second lens unit enclosure 163 via the second opening 163a. The second cover member 635 is detachable from and attachable to the second lens unit enclosure 163 to block part of the second opening 163a. The second cover member 635 is made, for example, of a plastic material. The second cover member 635 may be formed of a single member or a plurality of members.

The second reflection mirror 162 in the present embodiment includes the base 620 having the inner surface 620a on which the reflection layer 621 is formed, and a second heat dissipation member 625. The second heat dissipation member 625 is provided at part of the outer surface 620b of the base 620. The second heat dissipation member 625 in the present embodiment also serves as a cover member that blocks part of the second opening 163a. The second heat dissipation member 625 along with the second cover member 635 blocks the second opening 163a. More specifically, the second heat dissipation member 625 blocks the portion of the second opening 163a that is not blocked by the second cover member 635. That is, in the present embodiment, the entire second heat dissipation member 625 of the second reflection mirror 162 is exposed to the space outside the second lens unit enclosure 163.

The second heat dissipation member 625 and the second cover member 635 hermetically seal the interior space of the second lens unit enclosure 163, and therefore suppress degradation in the optical characteristics of the lens group 61 and the reflection layer 621 housed in the second lens unit enclosure 163 due to dust that adheres thereto, and deformation of and damage to the lens group 61 and the reflection layer 621 due to the dust caused to burn.

The second heat dissipation member 625 in the present embodiment is bonded to the outer surface 620b of the base 620. In the present embodiment, the heat conductive member 626, such as heat dissipation grease, is sandwiched between the second heat dissipation member 625 and the outer surface 620b of the base 620. The heat conductivity between the second heat dissipation member 625 and the base 620 can thus be improved.

The second heat dissipation member 625 is a heat sink including a base section 625a and heat dissipating fins 625b coupled to the base section 625a. The base section 625a is a metal plate provided along the outer surface 620b. The heat dissipating fins 625b are formed of a plurality of fin-shaped members and correspond to the protrusion protruding from the outer surface 620b. Out of the heat dissipating fins 625b, those provided at the outer edge of the base section 625a function as a fixing portion that fixes the second heat dissipation member 625 to the second cover member 635, as will be described later.

The second reflection mirror 162 in the present embodiment has a configuration in which the base 620 on which the reflection layer 621 is deposited is fixed to the supports 631a of the mirror holder 631 with first screw members 71. The second heat dissipation member 625 is fixed to the second lens unit enclosure 163 along with the second cover member 635 with second screw members 72. The base 620 and the second heat dissipation member 625 are bonded to each other via the heat conductive member 626.

The step of assembling the projection optical apparatus 106 according to the present embodiment will now be described.

First, the second heat dissipation member 625 is bonded to the outer surface 620b of the base 620, on which the reflection layer 621 has been deposited, via the heat conductive member 626 to assemble the second reflection mirror 162.

Subsequently, the second reflection mirror 162 is placed in the second lens unit enclosure 163 via the second opening 163a, and the second reflection mirror 162 is then fixed to the supports 631a of the mirror holder 631 with the first screw members 71. The second cover member 635 is then attached to the second lens unit enclosure 163. The second opening 163a of the second lens unit enclosure 163 is thus blocked with the second heat dissipation member 625 of the second reflection mirror 162 and the second cover member 635.

Finally, the second heat dissipation member 625 of the second reflection mirror 162 and the second cover member 635 are fixed to the second lens unit enclosure 163 with the second screw members 72.

The assembly of the projection optical apparatus 106 is thus completed.

The projection optical apparatus 106 according to the present embodiment, which includes the second reflection mirror 162 including the second heat dissipation member 625 provided at the side opposite from the reflection layer 621, which reflects the image light IL, can lower the temperature of the second reflection mirror 162 through dissipation of the heat of the reflection layer 621 via the second heat dissipation member 625. The projection optical apparatus 106 according to the present embodiment, which suppresses deformation of the second reflection mirror 162 due to a locally high temperature of the reflection layer 621, can therefore project a high-quality image having a suppressed partial shift of the pixels of the projected image caused by the heat of the second reflection mirror 162.

### Third Embodiment

Another configuration of the projection optical apparatus will be subsequently described as a third embodiment of the present disclosure. The present embodiment and the first embodiment differ from each other in terms of the structure of the reflection mirror, and the configurations of the reflection mirror and therearound will therefore be primarily described below. In the present embodiment, configurations or members common to those in the first embodiment have the same reference characters and will not be described in detail.

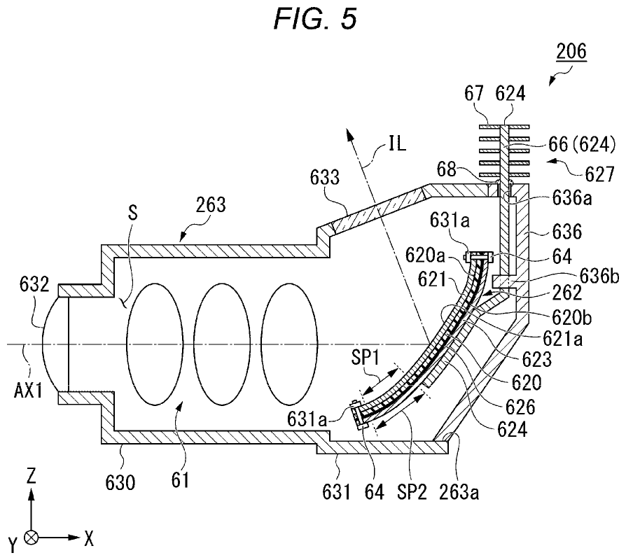

FIG. 5 is a cross-sectional view showing a schematic configuration of the projection optical apparatus according to the present embodiment.

A projection optical apparatus 206 according to the present embodiment includes the lens group 61, a third reflection mirror (reflector) 262, and a third lens unit enclosure (enclosure) 263, which houses the lens group 61 and the third reflection mirror 262, as shown in FIG. 5.

The third lens unit enclosure 263 in the present embodiment includes the lens barrel 630, the mirror holder 631, the light incident section 632, the light exiting section 633, and a third cover member 636.

The mirror holder 631 of the third lens unit enclosure 263 has a third opening 263a. The third opening 263a causes the interior space of the third lens unit enclosure 263 to communicate with the exterior thereof. The lens group 61 and the third reflection mirror 262 are detachable from and attachable to the interior of the third lens unit enclosure 263 via the third opening 263a. The third cover member 636 is detachable from and attachable to the third lens unit enclosure 263 to block the third opening 263a. The third cover member 636 is made, for example, of a plastic material. The third cover member 636 may be formed of a single member or a plurality of members.

The third reflection mirror 262 in the present embodiment includes the base 620 having the inner surface 620a on which the reflection layer 621 is formed, a third heat dissipation member 627, and the heat conductive member 626.

The third heat dissipation member 627 in the present embodiment includes the sheet metal member 623 provided along the outer surface 620b of the base 620, and the heat pipe 624 connected to the sheet-metal member 623 and protruding from the outer surface 620b.

The third reflection mirror 262 in the present embodiment and the first reflection mirror 62 in the first embodiment differ from each other in terms of the direction in which the heat pipe extends. The heat pipe 624 in the first embodiment extends toward the rear side of the outer surface 620b of base 620 diagonally downward (toward positive end of direction X and negative end of direction Z). In contrast, the heat pipe 624 in the present embodiment extends toward the rear side of the outer surface 620b of base 620 diagonally upward (toward positive end of direction X and positive end of direction Z) with a small distance between the heat pipe 624 and the outer surface 620b, and then extends upward (toward positive end of direction Z).

In the present embodiment, the heat dissipating section 66 of the heat pipe 624 is exposed to the space outside the third lens unit enclosure 263 via a third slit 636a provided in the third cover member 636. The heat pipe 624 has a configuration in which the heat dissipating section 66, which is exposed to the space outside the third lens unit enclosure 263, is provided with the heat dissipating fins 67. The gap between the heat dissipating section 66 and the third slit 636a is filled with the sealing member 68. The interior of the third lens unit enclosure 263 is thus hermetically sealed.

The third cover member 636 in the present embodiment includes a pipe holder 636b, which holds part of the heat pipe 624. The heat pipe 624 is thus held by the third lens unit enclosure 263 via the third cover member 636, whereby the heat pipe 624 can be held in a stable manner. Therefore, rattling of the heat pipe 624 can be suppressed, and disconnection between the heat pipe 624 and the sheet metal member 623 and other problems can be avoided.

The step of assembling the projection optical apparatus 206 according to the present embodiment will now be described.

First, the third heat dissipation member 627 is caused to come into contact with the outer surface 620b of the base 620, on which the reflection layer 621 has been deposited, via the heat conductive member 626 with the aid of the screw members 64 to assemble the third reflection mirror 262.

The third cover member 636 is subsequently attached to the third lens unit enclosure 263 to block the third opening 263a. At this point of time, the heat dissipating section 66 of the heat pipe 624 is exposed to the space outside the third lens unit enclosure 263 via the third slit 636a of the third cover member 636.

The heat dissipating fins 67 are subsequently attached to the heat dissipating section 66 of the heat pipe 624, which is exposed to the space outside the third lens unit enclosure 263.

Finally, the gap between the third slit 636a of the third cover member 636 and the heat pipe 624 is filled with the sealing member 68. The assembly of the projection optical apparatus 206 is thus completed.

The projection optical apparatus 206 according to the present embodiment, which includes the third reflection mirror 262 including the third heat dissipation member 627 to suppress deformation of the third reflection mirror 262 due to a locally high temperature of the reflection layer 621, can also project a high-quality image having a suppressed partial shift of the pixels of the projected image caused by the heat of the third reflection mirror 262.

### Fourth Embodiment

Another configuration of the projection optical apparatus will be subsequently described as a fourth embodiment of the present disclosure. The present embodiment and the first embodiment differ from each other in terms of the structure of the reflection mirror, and the configurations of the reflection mirror and therearound will therefore be primarily described below. In the present embodiment, configurations or members common to those in the first embodiment have the same reference characters and will not be described in detail.

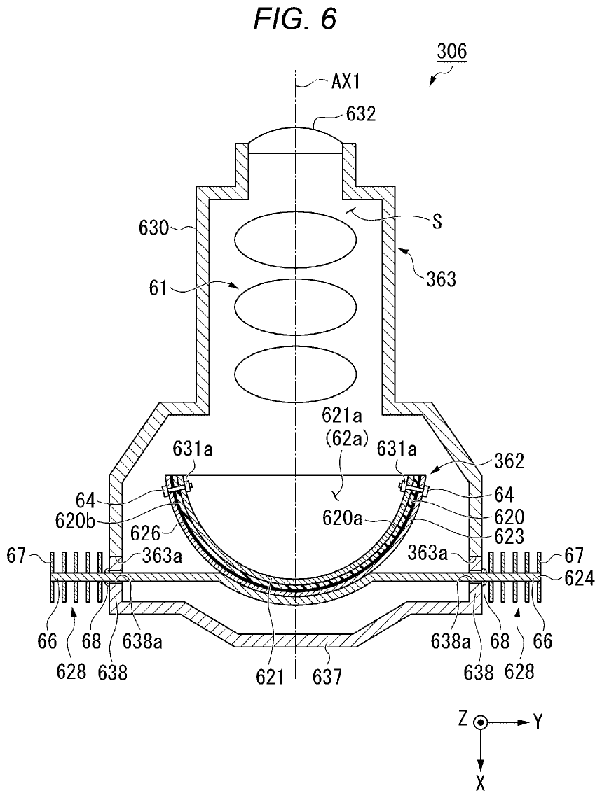

FIG. 6 is a cross-sectional view showing a schematic configuration of the projection optical apparatus according to the present embodiment. FIG. 6 is a cross-sectional view of the projection optical apparatus taken along a plane parallel to the plane XY.

A projection optical apparatus 306 according to the present embodiment includes the lens group 61, a fourth reflection mirror (reflector) 362, and a fourth lens unit enclosure (enclosure) 363, which houses the lens group 61 and the fourth reflection mirror 362, as shown in FIG. 6.

The fourth lens unit enclosure 363 in the present embodiment includes the lens barrel 630, the mirror holder 631, the light incident section 632, the light exiting section 633, and a fourth cover member 637.

The mirror holder 631 of the fourth lens unit enclosure 363 has a fourth opening 363a. The fourth opening 363a causes the interior space of the fourth lens unit enclosure 363 to communicate with the exterior thereof. The lens group 61 and the fourth reflection mirror 362 are detachable from and attachable to the interior of the fourth lens unit enclosure 363 via the fourth opening 363a. The fourth cover member 637 is detachable from and attachable to the fourth lens unit enclosure 363 to block the fourth opening 363a. The fourth cover member 637 is made, for example, of a plastic material. The fourth cover member 637 may be formed of a single member or a plurality of members.

The fourth reflection mirror 362 in the present embodiment includes the base 620 having the inner surface 620a on which the reflection layer 621 is formed, a fourth heat dissipation member 628, and the heat conductive member 626.

The fourth heat dissipation member 628 in the present embodiment includes the sheet metal member 623 provided along the outer surface 620b of the base 620, and the heat pipe 624 connected to the sheet metal member 623 and protruding from the outer surface 620b.

The fourth reflection mirror 362 in the present embodiment and the third reflection mirror 262 in the third embodiment differ from each other in the direction in which the heat pipe extends. The heat pipe 624 in the third embodiment extends toward the rear side of the outer surface 620b of base 620 diagonally upward (toward positive end of direction X and positive end of direction Z) with a small distance between the heat pipe 624 and the outer surface 620b, and then extends upward (toward positive end of direction Z). In contrast, the heat pipe 624 in the present embodiment is provided along the rear surface of the outer surface 620b of the base 620 and extends toward the opposite ends in the rightward-leftward direction (axis-Y direction).

The fourth cover member 637 in the present embodiment includes a pipe holder 638, which holds the opposite ends of the heat pipe 624 in the rightward-leftward direction. The heat pipe 624 is thus held by the fourth lens unit enclosure 363 via the fourth cover member 637, whereby the heat pipe 624 can be held in a stable manner. Therefore, rattling of the heat pipe 624 can be suppressed, and disconnection between the heat pipe 624 and the sheet metal member 623 and other problems can be avoided.

In the present embodiment, the heat dissipating sections 66 of the heat pipe 624 are exposed to the space outside the fourth lens unit enclosure 363 via fourth slits 638a provided in the pipe holder 638 of the fourth cover member 637. The heat pipe 624 has a configuration in which the heat dissipating sections 66, which are exposed to the space outside the fourth lens unit enclosure 363, are provided with the heat dissipating fins 67. The gaps between the heat dissipating sections 66 and the fourth slits 638a are filled with the sealing members 68. The interior of the fourth lens unit enclosure 363 is thus hermetically sealed.

The step of assembling the projection optical apparatus 306 according to the present embodiment will now be described.

First, the fourth heat dissipation member 628 is caused to come into contact with the outer surface 620b of the base 620, on which the reflection layer 621 has been deposited, via the heat conductive member 626 with the aid of the screw members 64 to assemble the fourth reflection mirror 362.

The fourth cover member 637 is subsequently attached to the fourth lens unit enclosure 363 to block the fourth opening 363a. At this point of time, the heat dissipating sections 66 of the heat pipe 624 are exposed to the space outside the fourth lens unit enclosure 363 via the fourth slits 638a of the pipe holder 638 of the fourth cover member 637.

The heat dissipating fins 67 are subsequently attached to the heat dissipating sections 66 of the heat pipe 624, which are exposed to the space outside the fourth lens unit enclosure 363.

Finally, the gaps between the fourth slits 638a of the pipe holder 638 and the heat pipe 624 are filled with the sealing members 68. The assembly of the projection optical apparatus 306 is thus completed.

The projection optical apparatus 306 according to the present embodiment, which includes the fourth reflection mirror 362 including the fourth heat dissipation member 628 to suppress deformation of the fourth reflection mirror 362 due to a locally high temperature of the reflection layer 621, can also project a high-quality image having a suppressed partial shift of the pixels of the projected image caused by the heat of the fourth reflection mirror 362.

The technical scope of the present disclosure is not limited to the embodiments described above, and a variety of changes can be made thereto to the extent that the changes do not depart from the intent of the present disclosure.

In addition to the above, the number, arrangement, shape, material, and other specific configurations of the variety of components that constitute the projection optical apparatus are not limited to those in the embodiments described above and can be changed as appropriate.

For example, the aforementioned embodiments have been described with reference to the case where the first reflection mirror 62 is a mirror having the concave reflection surface 62a, and the present disclosure is also applicable to a projection optical apparatus using a reflection mirror having a convex or planar reflection surface.

The aforementioned embodiments have been described with reference to the case where the protrusion, which is part of the heat dissipation member, protrudes outward from the lens unit enclosure, and the entire heat dissipation member may instead be housed in the lens unit enclosure. The thus configured projection optical apparatus, in which providing the heat dissipation member improves the heat dissipation capability of the reflection mirror, can also project a high-quality image having a suppressed partial shift of the pixels of the projected image due to the heat of the reflection mirror.

The aforementioned embodiments have been described with reference to the projection optical apparatus 6 used in the projector 1, which projects visible light as the image light onto the screen. Visible light is therefore used as the light projected by the projection optical apparatus 6. Depending on the type and application of the light source of the projector, however, a film that reflects near-infrared or infrared light may be used as the dielectric film that constitutes the reflection layer 621.

The light modulators 11R, 11G, and 11B are each not limited to a transmissive liquid crystal panel. The light modulators 11R, 11G, and 11B may instead each be a reflective light modulator, such as a reflective liquid crystal panel. Still instead, for example, a digital micromirror device that includes micromirrors as pixels and controls the direction in which light incident thereon exits on a micromirror basis to modulate the light emitted from the light source 21 may be employed. Furthermore, the configuration in which a light modulator is provided for each of a plurality of color luminous fluxes is not necessarily employed, and a single light modulator may modulate the plurality of color luminous fluxes in a time division manner.

In the embodiments described above, the light source apparatus according to the present disclosure is used in a projector by way of example, but not necessarily. The light source apparatus according to the present disclosure may be used as a lighting apparatus, such as a headlight of an automobile.

The present disclosure will be summarized below as additional remarks.

### Additional Remark 1

A projection optical apparatus including an optical system that image light enters, a reflector that reflects the light that exits out of the optical system, and an enclosure that houses the optical system and at least part of the reflector, the reflector including a base having a first surface on which the image light is incident and a second surface opposite from the first surface, a reflection layer provided at the first surface of the base, and a heat dissipation member provided at the second surface of the base and including a protrusion protruding from the second surface.

The projection optical apparatus according to the configuration described above, in which the reflector, which reflects light, includes the heat dissipation member opposite from the reflection layer, and the heat dissipation member dissipates heat absorbed from the reflection layer via the protrusion, can lower the temperature of the reflector.

Even when light having an uneven illuminance distribution containing locally high illuminance is incident on the reflection layer, the temperature of the reflection layer is satisfactorily lowered, whereby the situation in which local temperature unevenness occurs at the reflection layer can be suppressed.

The projection optical apparatus having the configuration described above, in which the reflection layer of the reflector is unlikely to become locally hot, therefore suppresses deformation of the hot portions of the reflector. A high-quality image having a suppressed partial shift of the projected image light caused by the heat of the reflector can therefore be projected.

### Additional Remark 2

The projection optical apparatus described in the additional remark 1, in which an illuminance distribution formed by the light at the reflection layer has a first region where the illuminance is higher than a predetermined value, and the heat dissipation member is provided at the second surface at least at a second region thereof corresponding to the first region.

According to the configuration described above, in which a heat conductive layer is provided at least at the second region of the second surface as described above, the heat can be efficiently dissipated from the first region, which is the hottest region of the surface of the reflection layer, toward the heat conductive layer. The temperature of the first region, which is the hottest region, is therefore efficiently lowered, whereby the temperature of the reflector can be efficiently lowered.

### Additional Remark 3

The projection optical apparatus described in the additional remark 1 or 2, in which the heat dissipation member is a heat sink including a heat dissipating fin as the protrusion, and at least part of the heat dissipating fin is exposed to a space outside the enclosure.

According to the configuration described above, the heat absorbed by the heat sink from the reflection layer can be efficiently dissipated from the portion exposed to the space outside the enclosure. The cooling performance of the reflector can thus be improved. Furthermore, since the heat sink does not release the heat inside the enclosure, an increase in the temperature of the interior of the enclosure can be suppressed.

### Additional Remark 4

The projection optical apparatus described in the additional remark 1 or 2, in which the heat dissipation member includes a heat pipe as the protrusion, and at least part of the heat pipe is exposed to a space outside the enclosure.

According to the configuration described above, the heat absorbed by the heat pipe from the reflection layer can be efficiently dissipated from the portion exposed to the space outside the enclosure. The cooling performance of the reflector can thus be improved. Furthermore, since the heat pipe does not release the heat inside the enclosure, an increase in the temperature of the interior of the enclosure can be suppressed.

### Additional Remark 5

The projection optical apparatus described in the additional remark 4, in which a heat dissipating fin is provided at a portion of the heat pipe that is exposed to the space outside the enclosure.

According to the configuration described above, the heat dissipation capability of the heat pipe is improved by the heat dissipating fin, whereby the cooling performance of the reflector can be further enhanced.

### Additional Remark 6

The projection optical apparatus described in any one of the additional remarks 1 to 5, in which the enclosure has a hermetically sealed structure that seals a housing space that houses the optical system and the reflector.

The configuration described above, which suppresses entry of dust into the housing space in the enclosure, suppresses deterioration in the optical characteristics of the optical system and the reflector due to dust that adheres thereto, and deformation of and damage to the optical system and the reflector due to the dust caused to burn.

### Additional Remark 7

The projection optical apparatus described in any one of the additional remarks 1 to 6, in which the base is made of a plastic material.

The configuration described above can improve the workability of the reflector. The reflector can therefore be readily processed into a desired shape.

### Additional Remark 8

The projection optical apparatus described in any one of the additional remarks 1 to 7, in which the reflection layer has a concave shape.

According to the configuration described above, in which the reflector including the concave reflection layer is provided, a single-focus projection optical apparatus can be provided.

### Additional Remark 9

The projection optical apparatus described in any one of the additional remarks 1 to 8, in which the heat dissipation member also serves as a cover member that blocks an opening provided in the enclosure.

According to the configuration described above, in which the heat dissipation member also serves as a cover member that blocks the opening of the enclosure, the number of parts that constitute the projection optical apparatus can be reduced. The cost of the projection optical apparatus can thus to be reduced.

### Additional Remark 10

The projection optical apparatus described in any one of the additional remarks 1 to 9, in which the image light that exits via a reduction-side conjugate plane enters the optical system, and the reflector reflects and projects the image light into an enlargement-side conjugate plane.

According to the configuration described above, a single-focus projection optical apparatus that projects a display image in the reduction-side conjugate plane into the enlargement-side conjugate plane to generate projected image light can be provided.

### Additional Remark 11

A projector including a light source apparatus that outputs light, a light modulator that modulates the light from the light source apparatus, and the projection optical apparatus described in any one of additional remarks 1 to 10 that projects modulated image light from the light modulator.

The thus configured projector, which includes the projection optical apparatus, which suppresses a partial shift of the projected image light caused by the heat of the reflector, can be a single-focus projector that projects a high-quality image onto a screen over a short distance.

The projector having the configuration described above, which can suppress a partial shift of the image light projected onto the screen, is optimum for a projector having an interactive function of reflecting on-screen detected position information in the projected image.

What is claimed is:

1. A projection optical apparatus comprising:
an optical system that image light enters;
a reflector that reflects the image light that exits out of the optical system; and
an enclosure that houses the optical system and at least part of the reflector,
wherein the reflector includes
a base having a first surface on which the image light is incident and a second surface opposite from the first surface,
a reflection layer provided at the first surface of the base, and
a heat dissipation member provided at the second surface of the base and including a protrusion protruding from the second surface.

2. The projection optical apparatus according to claim 1,
wherein an illuminance distribution formed by the image light at the reflection layer has a first region where the illuminance is higher than a predetermined value, and
the heat dissipation member is provided at the second surface at least at a second region thereof corresponding to the first region.

3. The projection optical apparatus according to claim 1,
wherein the heat dissipation member is a heat sink including a heat dissipating fin as the protrusion, and
at least part of the heat dissipating fin is exposed to a space outside the enclosure.

4. The projection optical apparatus according to claim 1,
wherein the heat dissipation member includes a heat pipe as the protrusion, and
at least part of the heat pipe is exposed to a space outside the enclosure.

5. The projection optical apparatus according to claim 4,
wherein a heat dissipating fin is provided at a portion of the heat pipe that is exposed to the space outside the enclosure.

6. The projection optical apparatus according to claim 1,
wherein the enclosure has a hermetically sealed structure that seals a housing space that houses the optical system and the reflector.

7. The projection optical apparatus according to claim 1,
wherein the base is made of a plastic material.

8. The projection optical apparatus according to claim 1,
wherein the reflection layer has a concave shape.

9. The projection optical apparatus according to claim 1,
wherein the heat dissipation member also serves as a cover member that blocks at least part of an opening provided in the enclosure.

10. The projection optical apparatus according to claim 1,
wherein the image light that exits via a reduction-side conjugate plane enters the optical system, and
the reflector reflects and projects the image light into an enlargement-side conjugate plane.

11. A projector comprising:
a light source apparatus that outputs light;
a light modulator that modulates the light from the light source apparatus; and
the projection optical apparatus according to claim 1 that projects modulated image light from the light modulator.
